(19) United States
(12) Patent Application Publication
(10) Pub. No.: US 2026/0298393 A1
(43) Pub. Date: Oct. 1, 2026

(54) COMPLEMENTARY HOSE BIB PROTECTOR FOR OUTDOOR HOSE BIB

(71) Applicant: D5Wilson Partners LLC, San Antonio, TX (US)

(72) Inventors: Daniel L. Wilson, San Antonio, TX (US); Diane I. Wilson, San Antonio, TX (US)

(73) Assignee: D5Wilson Partners LLC, San Antonio, TX (US)

(21) Appl. No.: 19/636,054

(22) Filed: Apr. 1, 2026

Related U.S. Application Data
(60) Provisional application No. 63/781,687, filed on Apr. 1, 2025.

(51) Int. Cl. F16L 57/00

(52) U.S. Cl. CPC F16L 57/005

(57) ABSTRACT

A complementary hose bib protector and method of use. The complementary hose bib protector comprises a body made from a material that is water-resistant or water proof and preferred for below-ambient applications. The material may further be flexible and compressible. The complementary hose bib protector establishes a good seal against the building, hose bib and pipe, preventing water in the hose bib from freezing. The complementary hose bib protector pushes against the hose bib cover and into crevices and seals around the plumbing extending from the structure to the hose bib, thereby forming a seal and maintaining a pocket of warm air within the hose bib cover.

### CROSS REFERENCE TO RELATED APPLICATIONS

This patent application is based on and claims priority to U.S. provisional patent application Ser. No. 63/781,687, which is entitled “The HB Plus, a Novel Complementary Device to a Hose Bib Insulation Cover to Prevent Breakage Due to Freezing Temperatures,” filed Apr. 1, 2025, the entire disclosure of which is incorporated herein by reference.

### TECHNICAL FIELD OF THE INVENTION

The present invention relates generally to devices for protecting outdoor spigots, and more particularly, but not by way of limitation, to complementary protective devices used in connection with covers for outdoor spigots. Methods of protecting outdoor spigots from freezing also are disclosed.

### SUMMARY OF THE INVENTION

The present invention is directed to a complementary hose bib protector for use with a hose bib cover, the complementary hose bib protector comprising: a body, wherein: the body comprises a material that is insulative and water-resistant or water proof; and the body forms an aperture adapted to enable the complementary hose bib protector to be assembled in configuration with a hose bib cover.

The present invention further is directed to a kit for protecting a hose bib, the kit comprising: a hose bib cover; and a complementary hose bib protector for use with the hose bib cover, the complementary hose bib protector comprising: a body, wherein: the body comprises a material that is insulative and water-resistant or water proof; and the body forms an aperture adapted to enable the complementary hose bib protector to be assembled in configuration with a hose bib cover.

The present invention further is directed to a method of protecting a hose bib, the method comprising the steps of: providing a hose bib protector comprising a body, wherein: the body comprises a material that is insulative and water-resistant or water proof; and the body forms an aperture adapted to enable the complementary hose bib protector to be assembled in configuration with a hose bib cover.

### BRIEF DESCRIPTION OF THE DRAWINGS

The figures are provided for purposes of illustration only and merely depict typical or illustrative embodiments.

FIG. 1A shows a conventional outdoor hose bib configured on the exterior of a building for delivering water to an outdoor supply.

FIG. 1B shows a conventional hose bib cover installed over a hose bib on an irregular exterior siding wall surface.

FIG. 2 shows an isometric view of an illustrative complementary hose bib protector constructed according to an embodiment of the present invention.

FIG. 3 shows a top plan view of an illustrative complementary hose bib protector constructed according to an embodiment of the present invention.

FIG. 4 shows an illustrative complementary hose bib protector constructed according to an embodiment of the present invention and installed in configuration with a conventional hard foam outdoor hose bib cover over an irregular exterior surface.

FIG. 5 shows an illustrative complementary hose bib protector constructed according to an embodiment of the present invention and installed in configuration with a conventional soft sock hose bib cover over an irregular exterior surface

### DETAILED DESCRIPTION OF THE INVENTION

Exterior hose bibs, water spigots and pipes that are not properly insulated are prone to freeze and burst, causing water damage and incurring costly repairs. The breakage is due to freezing temperatures and ice expansion of frozen water inside pipes leading from a building to the hose bib. During periods of hard freeze, almost any home or building that does not have adequately protected hose bibs may endure the hardship occasioned by frozen hose bibs that have burst. Due to the increased demand for plumbers to repair split hose bibs or pipes, it may require several days before a plumber can be dispatched to a building for repair. Occupants of the building may be without water for days until a plumber can be dispatched to repair the burst hose bib.

Hose bib covers are utilized in climates that are subject to freezing temperatures to form a radiant barrier that will help reduce heat loss from water pipes, hose bibs, and hose bib covers. Building materials, such as limestone and brick, have a low thermal conductivity, which is ability of the material to effectively transfer heat. Building materials used to construct the exterior wall of a structure help keep extreme temperatures, whether hot or cold, from entering the structure due to cavities in the material that contain air bubbles and spaces therebetween, which cause the material to have an extremely high thermal resistance and low thermal conductivity. Therefore, the temperature of the exterior wall has no bearing on whether the temperature of the water in the plumbing and hose bib attached thereto will freeze, because the building is not absorbing significant heat, if any, away from the pipe or hose bib.

Conventional outdoor hose bib covers work by trapping heat that radiates from the indoor pipes to the outdoor hose bib, preventing freezing. A typical hose bib cover only prevents freezing if heat that radiates from the indoor plumbing to the outdoor hose bib is trapped within the hose bib cover. This trapped heat warms the pocket of air within the cover to prevent water in the hose bib from freezing. Any leakage of the seal between the hose bib cover and the building will allow freezing air to enter the hose bib cover, and the hose bib likely will freeze. To ensure that a hose bib cover effectively protects the hose bib from freezing temperatures, it is imperative that a tight seal around the hose bib by the hose bib cover is established. Nevertheless, extremely low temperatures, or prolonged exposure to low temperature conditions, may still lead to freezing under certain conditions.

The only purpose of a typical hose bib cover is to prevent air or ice that has a temperature below the freezing point of water from coming into contact with the pipe and hose bib to which it is attached. Many hose bib covers that slip over a hose bib during harsh winter weather are made of polystyrene and have a foam gasket that helps trap warm air generated from the building's plumbing. Some are made of other materials that form a sock or bag that is placed over a hose bib for insulation. Freezing is more likely to occur if a hose bib is not adequately covered and insulated. This is especially problematic if there are gaps in the exterior surface of the building and the gasket of the hose bib cover prevents a seal from being formed between the building and the hose bib cover, which causes heat from the pipes to be lost.

Conventional hose bib covers fail to provide a tight seal against the exterior surface and may not work adequately when used against an irregular surface. Hose bib covers that are worn or have deteriorated foam bodies or gaskets lose their heat retention capacity and permit freezing of the hose bib. Over time, the strip of foam or gasket at the base of the hose bib cover will dry rot or be unable to prevent heat transfer. When this occurs, the foam on the hose bib cover will not be able to form an adequate connection with the building, and a pocket of warm air will not be formed around the hose bib.

Moreover, the foam base of conventional hose bib covers, even in new condition, are not adapted to seal against a variety of uneven surfaces. If a typical hose bib cover is installed to protect a hose bib that extends from a building having exterior walls with an irregular surface, the small strip of foam on the hose bib cover will not be able to adequately seal against the wall to prevent the hose bib from freezing. Rock, brick and other irregular surfaces may have a gap with a depth larger than the gasket on a typical hose bib, which prevents formation of a seal. Therefore, freezing of the hose bib can occur and cause a rupture, resulting in costly repairs, as well as any additional costs for other water damage that may occur.

The subject invention relates to a novel complementary device which is designed to be used in conjunction with a conventional hose bib cover to aid in the prevention of damage to pipes and to hose bibs from breakage caused by freezing temperatures. The complementary hose bib protector of the present invention enables the temperature of the water in the hose bib to remain above freezing and acts as an insulator that will aid in prevention against freezing and rupturing of the hose bib and pipe. The complementary hose bib protector of the present invention fits snugly around the pipe extending from the structure to the hose bib, forming a seal around the pipe and, with the hose bib cover, prevents freezing air from sweeping heat generated by the temperature of the warmer house pipes and away from the pipe and hose bib. Additionally, no external heat source, such as radiant heat from an electrical light bulb in the hose bib cover, which can be a dangerous electrical hazard particularly in rainy or icy weather, is necessary. Maintaining this pocket of warm air around the hose bib is critical to the performance of any hose bib cover. The hose bib protector of the present invention aids in maintaining this pocket of warm air around the pipe and the hose bib by establishing a good seal with the hose bib cover and the building, thereby, helping to prevent the hose bib or pipe from freezing.

The complementary hose bib protector of the subject invention is elegantly easy to use by anyone, even technologically averse consumers, and eliminates the need for dangerous electrical cords. The subject invention is economical (saves money), is ecological (saves energy) by using the natural temperature of the water in the pipe as it exists in the home and enters the hose bib. The subject invention achieves the goal of preventing a frozen pipe or hose bib without any additional heat generating components.

The complementary hose bib protector of the present invention does not use insulation to prevent heat from the hose bib cover from being absorbed by the exterior wall of the house or building. The complementary hose bib protector of the present invention utilizes the heat from the plumbing and water as it exits the building and enters the hose bib. An external heat source is unnecessary for the subject invention to prevent freezing of the pipe or hose bib or the water therein. The subject invention fills in the gaps in rough, exterior surfaces while simultaneously fitting snugly over the pipe exiting the structure and creating a secure connection with or against a hose bib cover, thereby helping to form a seal with the hose bib cover and maintaining a warm pocket of air around the pipe and hose bib.

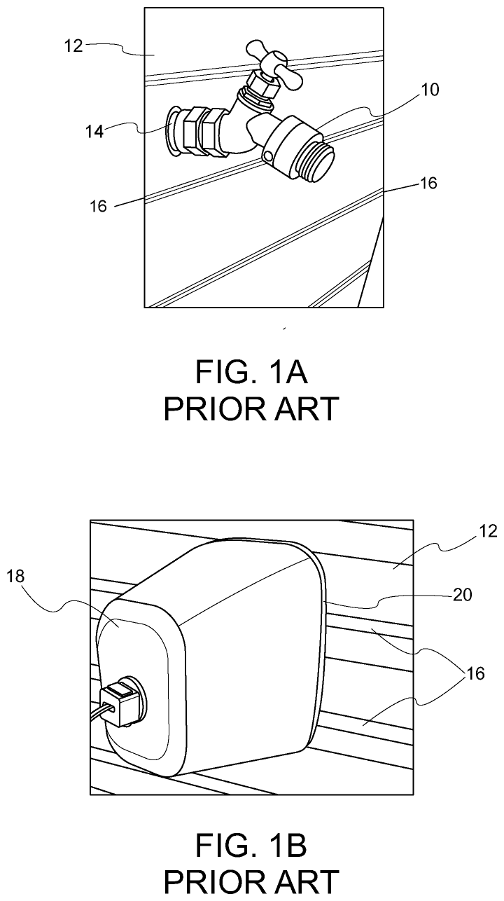

Turning now to the drawings in general, and to FIGS. 1A and 1B in particular, there is shown therein a hose bib 10 on the exterior of a building or other structure 12. A pipe 14 exits the building 12 and connects to the hose bib 10 for the delivery of potable water. The exterior 12 of the building comprises siding, brick, rock or other exterior building material, which forms clefts, hollows, grout lines, depressions, indentations, voids, or gaps 16 to create an uneven exterior surface. As used herein, the phrase “hose bib” includes hose bibbs, water spigots and exterior water faucets. The term “pipe” may be used herein to refer to the pipe 14 alone or to both the hose bib 10 and the pipe 14 collectively, depending upon the context. The term “building” includes homes, commercial buildings, and any other residential, commercial or industrial buildings and structures, as well as stand-alone water supply pipes that have an external hose bib from which water can flow and is subject to freeze.

The hose bib 10 and pipe 12 are protected by a hose bib cover 18. While FIG. 1B depicts a conventional hard foam hose bib cover 18, it will be appreciated that the subject invention is adaptable for use with any type of hose bib cover, whether a hard or a soft style, such as hard foam covers, hard plastic shell covers, padded soft faucet covers, or thermal/insulated faucet socks. The hose bib cover 18 illustrated in FIG. 1B comprises a rigid, cup-shaped insulator formed from a hard foam, such as Styrofoam®, and comprises a gasket 20 that abuts the exterior of the building 12.

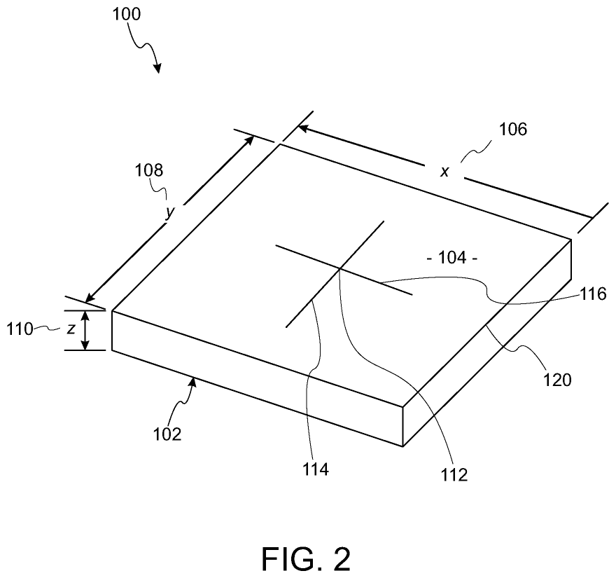

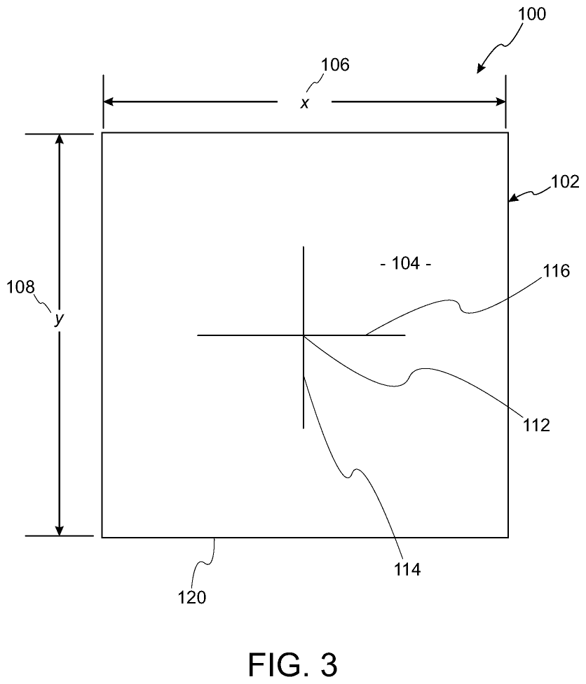

Turning now to FIGS. 2 and 3, there is shown therein an illustrative complementary hose bib protector 100 for use in conjunction with, not as a replacement for, a hose bib cover 18. The hose bib protector 100 of the present invention is complementary to and is used in conjunction with the hose bib cover 18. The complementary hose bib protector 100 will act as a vapor barrier, inhibiting water and freezing air from contacting the pipe 14 and/or hose bib 10. The warmer, trapped air in a hose bib cover 18 that is generated by the natural temperature of the water in the pipe as it exists in the home and enters the hose bib 10 prevents the hose bib from freezing. The complementary hose bib cover 100 aids in the insulation of the hose bib 10 and pipe 14 by helping to form a better seal with the gasket 20 of the hose bib cover 18.

The complementary hose bib protector 100 comprises a body 102 made from a material 104 that is water-resistant or waterproof and preferred for below-ambient applications due to its structure. For below-ambient applications, a closed-cell insulative material 104, such as flexible closed-cell foams, are useful in the present invention due to their low water vapor transmission and inherent moisture resistance, making them ideal where temperatures are below freezing and rain or snow may be present. A closed cell foam material 104 forms individual air pockets or “cells” which are completely enclosed and not interconnected to each other, resulting in a firm, water-resistant or waterproof, highly insulating material compared to open cell foam. Thus, the closed cell insulation material 104 forms microscopic spheres of air that are contained within their distinct interconnected walls that prevent moisture or freezing air from penetrating through the insulation material and into or onto the pipe and hose bib, thereby forming greater protection against freezing. Thus, the material 104 has high porosity and low permeability. Open cell insulation material is permeable in that it does not form closed cells and acts like a sponge, absorbing water and freezing air which can come into contact with the pipe 14 and hose bib 10, causing them to freeze and burst. Closed cell material 104 is not permeable and prohibits the passage of water through the body 102 of the complementary hose bib protector 100 and onto the pipe 14 or hose bib 10.

Closed cell insulation material 104 adaptable for use in the present invention comprises a high R-value, requires no maintenance, and can be easily installed in just a few minutes. An R-factor is a measure of the ability of a material to resist heat flow and rates the insulative effectiveness of the material being used. The higher the R-value, the greater the material's ability to resist heat transfer and it will perform better as an insulating material. A material 104 having an R-value of at least 6.0 is useful in extreme temperature conditions. This will aid in the prevention of the flow of heat away from the hose bib or the pipe attached thereto, therefore, aiding to prevent them from freezing. A closed-cell foam has an R-value of approximately 6.0, versus an R-value of approximately 3.5 for open cell materials, which is significantly lower than closed cell foams and is not recommended for use in extreme temperature conditions. Examples of materials suitable for use in the present invention include polystyrenes, polyisocyanurates, polyurethane, expanded perlite, phenolic foams and insulations facings. Examples of soft closed-cell materials suitable for use in the invention include synthetic rubber, silicone foams, polyethylene foams, low-density polyethylene (LDPE) foams, cross-linked polyethylene (XLPE), ethylene propylene diene monomer (EPDM), ethylene vinyl acetate (EVA), neoprene, synthetic rubbers, vinyl nitriles, neoprene and combinations of the foregoing.

The material 104 comprising the body 102 may be dense, yet conformable, and adaptable to fill a variety of different shapes of clefts, hollows, grout lines, depressions, indentations, voids, or gaps 16 in the uneven exterior surface of the structure 12. The material 104 may possess characteristics of flexibility and compressibility, which will allow the hose bib cover 10 to form and maintain a pocket of warm air around the hose bib 10. For example, the material comprising the complementary hose bib protector 100 is adaptable to fill asymmetrical, dissimilar voids 16 between rocks, even grid-like spaces between bricks, or linear indentations of varying and descending depths between strips of siding. Therefore, the material is better able to keep freezing air away from the pipe 14 and hose bib 10 than the conventional hose bib cover 10, alone. The complementary hose bib protector 100 pushes further into the clefts, hollows, grout lines, depressions, indentations, voids, or gaps 16 in the uneven exterior surface of the structure 12 while sealing snugly around the pipe 14 extending from the structure to the hose bib 10, thereby forming a seal which allows the hose bib cover 18 to maintain the pocket of warm air generated by the natural temperature of the water in the pipe as it exists in the structure and as it exits the structure and enters the hose bib. The flexibility and compressibility of the material 104 also enables the complementary hose bib protector to conform securely against the hose bib cover in a manner yet to be described.

The length of time that the complementary hose bib protector 100 prevents the hose bib 18 from freezing depends on factors such as the quality of the foam and the quality of the seal the foam makes with the pipe 14 and hose bib cover. In conjunction with the hose bib cover 18, hose bib protector 100 helps form a radiant barrier that will reduce heat loss from the hose bib cover, thereby reducing the possibility of freezing hose bibs. Air leakage that bypasses the gasket 20 of the hose bib cover 18, when used alone, will remove heat that should have been trapped inside the hose bib cover to prevent freezing. The complementary hose bib protector 100 prevents air leakage into the hose bib cover 18 and around the hose bib 10 and pipe 14, thereby helping to form a radiant barrier to freezing outdoor temperatures. This will aid in preventing the hose bib from bursting due to contact with below freezing outdoor temperatures. The complementary hose bib protector 100 prevent the need for using expensive duct tape to cover any gaps left between the gasket 20 of the hose bib cover 18 and the irregular wall surface of the structure 12.

The shape of the body 102 of the complementary hose bib protector 100 will vary with the application. The shape of the body 102 may comprise a circle, square, rectangle rhombus, parallelogram, or other shape adaptable to the conditions and environment where the complementary hose bib protector 100 will be installed. In some applications, the location and accessibility of the hose bib 10 and pipe 14 make them difficult to reach and necessitates adaptation of the complementary hose bib protector 100 to a unique configuration suited to the particular environment. It now will be appreciated that the soft material 104 comprising the body 102 of the hose bib protector 100, in addition to preserving heat, may be cut or otherwise adapted to any shape desired to facilitate installation under the conditions of the environment in which installed.

The dimensions of the body 102 of the complementary hose bib protector 100 will vary with the application. In a typical application where the pipe 14 and hose bib 10 extend unobstructed from the structure 12, the dimensions of the body 102 will be sufficient to create a protective barrier against the structure and around the pipe and hose bib. In one embodiment of the invention, the body 102 of the complementary hose bib protector 100 comprises a square having a length x 106 that is about 7 inches (17.78 cm) and a width y 108 that is about 7 inches (17.78 cm) in width. However, the body 102 can be adapted to other dimensions, as well, as suited for the application, environment and conditions where used.

The depth z 110 of the body 102 of the complementary hose bib protector 100 should be of sufficient thickness to extend securely into the clefts, hollows, grout lines, depressions, indentations, voids, or gaps 16 of the uneven exterior surface of the structure 12 to create a secure boundary. In one embodiment of the complementary hose bib protector 100, the depth z 110 of the body 102 ranges from about 0.5 inches (1.27 cm) to 5 inches (12.7 cm) to enable the protector 100 to better seal against an irregular surface while also sealing against the pipe 14 coming from the structure 12 to the hose bib 10. In another embodiment of the invention, the depth z 110 of the body 102 ranges from about 1 inch (1.27 cm) to about 2 inches (12.7 cm). In another embodiment of the invention, the depth z 110 of the body 102 is about 1 inch (2.54 cm).

With continuing reference to FIGS. 2 and 3, the body 102 of the complementary hose bib protector 100 comprises an aperture 112 enabling the hose bib protector 100 to be assembled in configuration with a hose bib 12, a pipe 14 and/or a hose bib cover 18. The aperture 112 is positioned substantially centrally on and through the body 102 of the hose bib protector 100. It will be appreciated that the aperture 112 may comprise any shape and size enabling the hose bib protector 100 to be configured on, around or with the hose bib 10, pipe 14 and/or hose bib cover 18. For example, the aperture 112 may form a circular shape permitting the body 102 of the hose bib cover 100 to slide over the hose bib 10 and pipe 14 and be positioned against the structure 12. In one embodiment of the invention, the aperture 112 is formed by intersecting slits 114 and 116 configured substantially centrally in and through the body 102 of the hose bib protector 100. An aperture comprising intersecting slits 114 and 116 enables installation on or over the immovable fixtures of the hose bib 10 and pipe 14, while yet providing more complete coverage of and contact with the hose bib, pipe and hose bib cover. An aperture comprising intersecting slits 114 and 116 enables installation on or over hose bibs 10 and pipes 14 of varying sizes to better retain heat therewithin, thus providing adaptability to multiple and various types and sizes of hose bibs 10. In one embodiment of the invention, the intersecting slits 114 and 116 are substantially perpendicular and each measure approximately 2.5 inches (6.45 cm).

The body 102 of the complementary hose bib protector 100 may further comprise a coating or a protective layer 120 formed on a surface of the body that does not abut the building 12 or is opposite to the building when in installed configuration therewith. The coating or protective layer 120 shields the complementary hose bib protector 100 against the elements and guards against extreme temperatures, thus further protecting the hose bib 10 and the pipe 14 and water therewithin from freezing. Examples of suitable materials useful in creating the coating or protective layer 120 include silicone, silicone based materials, dimethicone, aminosilicones, siloxysilicates and anionic silicones, polysiloxane polymers, amino functional silicones, polyurea polyurethane coatings, fluoropolymers, polyaspartic coatings, and epoxy resins. The coating or protective layer 120 may be made from a substance that cooperates with the material 104 comprising the body 102 and that at least does not inhibit and preferably enhances the function of the complementary hose bib protector 100 while providing qualities that extend the life of the complementary hose bib protector. The coating or protective layer 120 may be provided on the face or outer surface of the complementary hose bib protector 100 that does not abut, or is opposite to, the exterior surface of the building 12 when in installed configuration therewith. The coating or protective layer 120 may also be provided on the sides comprising length x 106, width y 108 and depth z 110. In one embodiment of invention, the coating or protective layer 120 is not supplied on the face or surface of the body 102 that abuts the exterior surface of the building 12 so that the material 104 is free to form or compress into the clefts, hollows, grout lines, depressions, indentations, voids, or gaps 16 of the exterior of the building.

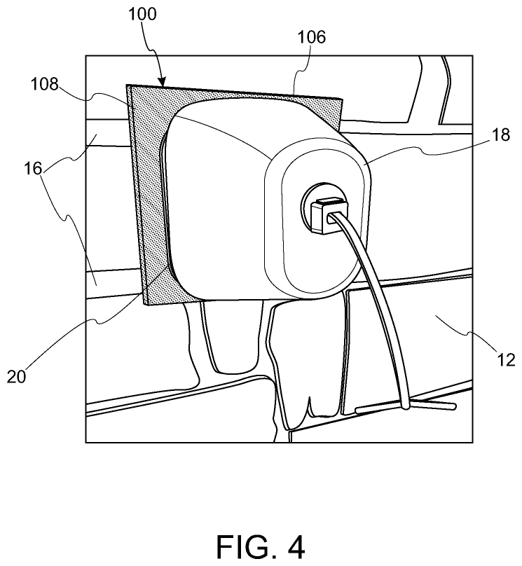

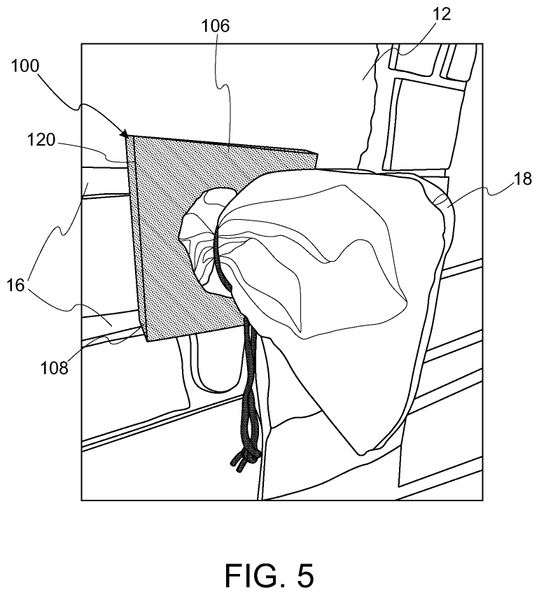

Turning now to FIGS. 4 and 5, the complementary hose bib protector 100 is shown in installed configuration and is demonstrated for use with a variety of different types of hose bib covers 18. The complementary hose bib protector 100 is easy to install in less than five minutes. The aperture 112 may be pre-cut or pre-formed in the body 102 or may be cut at the time of installation. The body 102 is moved over the hose bib 10 by sliding the aperture 112 against or over the water spout of the hose bib before the hose bib cover 18 is installed. The body 102 is pushed firmly against the building 12 and around the pipe 14. The material 104 of the complementary hose bib protector will naturally fill the clefts, hollows, grout lines, depressions, indentations, voids, or gaps 16 in the uneven exterior surface of the building 12. Additionally, the installer may facilitate installation by manually pressing the material 104 into the clefts, hollows, grout lines, depressions, indentations, voids, or gaps 16 in the uneven exterior surface of the building 12. The hose bib cover 10 is then installed over the hose bib 10 and secured against the complementary hose bib protector 100, which creates a tight seal against the protector and further presses the material 104 into the clefts, hollows, grout lines, depressions, indentations, voids, or gaps 16 in the uneven exterior surface of the building 12, thus helping to generate a pocket of warm air around the hose bib 10. Alternatively, the hose bib cover 18 may first be installed over the hose bib 10, after which the body 102 of the complementary hose bib protector 100 is moved over the hose bib cover 18 by sliding the aperture 112 over the hose bib cover toward the exterior surface of the building 12, after which the hose bib cover 18 is securely tightened against the complementary hose bib protector. It now will be appreciated that the flexibility and compressibility of the material 104 enables the complementary hose bib protector 100 to conform securely against the hose bib cover 18 and the exterior surface of the building 12.

At the end of the cold season, the complementary hose bib protector 100 is simply removed by sliding it over and off of the hose bib 10, the pipe 14, and/or the hose bib cover 18. The complementary hose bib protector 100 can be removed without leaving damage or residue behind on the hose bib 10, the exterior of the building 12, the pipe 14, or the hose bib cover 18. The complementary hose bib protector 100 can be reused and stored for later use during subsequent cold seasons.

It will now be appreciated that the complementary hose bib protector 100 of the present invention is a novel device that, when used in conjunction with a hose bib cover 18, will prevent air and water leakage into the hose bib cover and onto the hose bib 10, forming a radiant barrier against freezing outdoor temperatures and preventing breakage of the hose bib and pipe 14. The complementary hose bib protector 100 of the present invention will also eliminate the need for using expensive duct tape or other materials to cover the gaps left between the hose bib cover 18 and a building 12 from which the hose bib 10 extends. The complementary hose bib protector 100 of the present invention does not require an external heat source, which presents a fire hazard. The complementary hose bib protector 100 comprises a shape and material designed to cooperate in conjunction with a hose bib cover 10. The complementary hose bib cover 100 prevents freezing air and moisture from contacting the hose bib 10 and pipe 14, while adding additional insulation over the pipe and hose bib, which creates a seal against freezing temperatures and generates a warm pocket of air within the hose bib cover 18. The complementary hose bib protector 100 presses into the gaps, cracks, and voids 16 in walls of a structure 12 and seals around the pipe 14 coming from the structure 12 to the hose bib 10, thereby forming a seal which allows the hose bib cover 10 to maintain the pocket of warm air generated by the natural temperature of the water in the pipe as it exists in the home and enters the hose bib. The complementary hose bib protector is elegantly easy to use, even by the technologically averse, and it eliminates the need for dangerous electrical cords, saves money and saves energy by using the natural temperature of the water in the pipe as it exists in the home and enters the hose bib. The device is efficient and achieves the goal of preventing frozen pipes and hose bibs without any additional heat generating components. It also will be appreciated that the of material 104 from which the complementary hose bib protector is made will help establish the necessary seal for the hose bib cover 18 and pipe 14 so that the warm pocket of air generated from the hose bib 10 will not be whisked away by cold air due to a poor seal. In addition, material 104 will be resistant to water absorption, which will also help prevent the hose bib from freezing.

The terminology used herein is for the purpose of describing the invention and is not intended to be limiting of the invention. Unless otherwise defined, all terms in this document should be understood as having a meaning that is consistent with their meaning in the context of the invention as described herein. As used herein “approximately” and “generally” refer to manufacturing tolerances of permissible variations in physical properties of the embodiments disclosed herein. Dimensions, orientations, and/or configurations disclosed herein may have some acceptable variation within manufacturing tolerances without significantly affecting functioning of the disclosed embodiments. For example, while parallel and perpendicular relative arrangements and directions may be ideal, such configurations may not be perfectly achievable. Thus, substantially or approximately perpendicular and the like refers to a relative orientation or configuration within manufacturing tolerances. Similarly, generally or substantially linear and the like refers to a configuration within manufacturing tolerances.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known”. The presence of broadening words and phrases such as “one or more,” “at least,” “but not limited to” or other like phrases in some instances shall not be read to mean that the narrower case is intended or required in instances where such broadening phrases may be absent. The use of the term “component” or “assembly” or “unit” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple location.

Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

Additionally, the various embodiments set forth herein may be described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

The invention has been described above both generically and with regard to specific embodiments. Although the invention has been set forth in what has been believed to be preferred embodiments, a wide variety of alternatives known to those of skill in the art can be selected with a generic disclosure. Changes may be made in the combination and arrangement of the various parts, elements, steps and procedures described herein without departing from the spirit and scope of the invention as defined in the following claims.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

We claim:

1. A complementary hose bib protector for use with a hose bib cover, the complementary hose bib protector comprising:
a body, wherein:
the body comprises a material that is insulative and water-resistant or water proof; and
the body forms an aperture adapted to enable the complementary hose bib protector to be assembled in configuration with a hose bib cover.

2. The complementary hose bib protector of claim 1, wherein the material comprising the body comprises a closed-cell insulative material.

3. The complementary hose bib protector of claim 2, wherein the material is selected from the group consisting of polystyrenes, polyisocyanurates, polyurethane, expanded perlite, phenolic foams and insulations facings, synthetic rubber, silicone foams, polyethylene foams, low-density polyethylene (LDPE) foams, cross-linked polyethylene (XLPE), ethylene propylene diene monomer (EPDM), ethylene vinyl acetate (EVA), neoprene, synthetic rubbers, vinyl nitriles, neoprene and combinations of the foregoing.

4. The complementary hose bib protector of claim 3 wherein the aperture is positioned substantially centrally through the body.

5. The complementary hose bib protector of claim 4 wherein the aperture is formed by intersecting slits configured substantially centrally through the body.

6. The complementary hose bib protector of claim 4 further comprising a coating or a protective layer formed on a surface of the body.

7. The complementary hose bib protector of claim 6 wherein the coating or protective layer is selected from the group consisting of silicone, silicone based materials, dimethicone, aminosilicones, siloxysilicates and anionic silicones, polysiloxane polymers, amino functional silicones, polyurea polyurethane coatings, fluoropolymers, polyaspartic coatings, and epoxy resins.

8. A kit for protecting a hose bib, the kit comprising:
a hose bib cover; and
a complementary hose bib protector for use with the hose bib cover, the complementary hose bib protector comprising:
a body, wherein:
the body comprises a material that is insulative and water-resistant or water proof; and
the body forms an aperture adapted to enable the complementary hose bib protector to be assembled in configuration with a hose bib cover.

9. The kit for protecting a hose bib protector of claim 8, wherein the material comprising the body comprises a closed-cell insulative material.

10. The kit for protecting a hose bib of claim 9, wherein the material is selected from the group consisting of polystyrenes, polyisocyanurates, polyurethane, expanded perlite, phenolic foams and insulations facings, synthetic rubber, silicone foams, polyethylene foams, low-density polyethylene (LDPE) foams, cross-linked polyethylene (XLPE), ethylene propylene diene monomer (EPDM), ethylene vinyl acetate (EVA), neoprene, synthetic rubbers, vinyl nitriles, neoprene and combinations of the foregoing.

11. The kit protecting a hose bib of claim 9 wherein the aperture is positioned substantially centrally on and through the body.

12. The kit for protecting a hose bib of claim 11 wherein the aperture is formed by intersecting slits configured substantially centrally through the body.

13. The kit for protecting a hose bib of claim 12 wherein the body further comprise a coating or a protective layer formed on a surface of the body.

14. The kit for protecting a hose bib of claim 13 wherein the coating or protective layer is selected from the group consisting of silicone, silicone based materials, dimethicone, aminosilicones, siloxysilicates and anionic silicones, polysiloxane polymers, amino functional silicones, polyurea polyurethane coatings, fluoropolymers, polyaspartic coatings, and epoxy resins.

15. A method of protecting a hose bib, the method comprising the steps of:
providing a hose bib protector comprising a body, wherein:
the body comprises a material that is insulative and water-resistant or water proof; and
the body forms an aperture adapted to enable the complementary hose bib protector to be assembled in configuration with a hose bib cover.

16. The method of claim 15, further comprising the step of providing a hose bib cover.

17. The method of claim 16 further comprising the step of supplying an aperture in the body.

18. The method of claim 17 further comprising the step of moving the complementary hose bib protector over either the hose bib cover or the hose bib through the aperture in the body.

19. The method of claim 18 wherein the material comprises a closed-cell insulative material and further comprises the step of compressing the hose bib cover against the complementary hose bib protector.

20. The method of claim 19 further comprising the step of compressing the closed-cell insulative material against the building.
